(19) United States
(12) Patent Application Publication
(10) Pub. No.: US 2015/0328880 A1
(43) Pub. Date: Nov. 19, 2015

(54) DRIVE GEARS PROVIDING IMPROVED REGISTRATION IN PRINTING CYLINDER SYSTEMS

(71) Applicants: Matthias Hermann Regelsberger, Rochester, NY (US); Karlheinz Peter, Molfsee (DE)

(72) Inventors: Matthias Hermann Regelsberger, Rochester, NY (US); Karlheinz Peter, Molfsee (DE)

(21) Appl. No.: 14/280,714

(22) Filed: May 19, 2014

(51) Int. Cl. B41F 13/193

(52) U.S. Cl. CPC B41F 13/193

(57) ABSTRACT

A printing system for printing on a web of media traveling along a web transport path including a plurality of print stations located along the web transport path, each print station including a printing cylinder having a printing cylinder circumference for printing on the web of media at a corresponding print location. A plurality of web-transport rollers are used to guide the web of media along the web transport path. The printing system includes one or more constrained driven rollers having an affixed driven gear, the driven gear being driven by a motor using a gear train including one or more drive gears which transfer torque from the motor to the driven gear, wherein the driven gear and the drive gears associated with the constrained driven rollers are constrained to have a rotate an integer number of times for every rotation of the printing cylinders.

### CROSS REFERENCE TO RELATED APPLICATIONS

Reference is made to commonly assigned, co-pending U.S. patent application Ser. No. ______ (Docket K001744), entitled “Precision registration in printing cylinder systems” by K. Peter et al; to commonly-assigned, co-pending U.S. patent application Ser. No. ______ (Docket K001789), entitled “Precision Registration in a Digital Printing System” by Peter et al.; and to commonly assigned, co-pending U.S. patent application Ser. No. ______ (Docket K001799), entitled “Drive gears providing improved registration in digital printing systems” by K. Peter et al, each of which is incorporated herein by reference.

### FIELD OF THE INVENTION

This invention pertains to the field of printing cylinder systems, such as flexographic printers and offset printers, and more particularly to a web transport design for improved registration of printed patterns from different printing stations in a roll-to-roll web printing system.

### BACKGROUND OF THE INVENTION

Flexography is a method of printing or pattern formation that is commonly used for high-volume printing runs. It is typically employed for printing on a variety of soft or easily deformed materials including, but not limited to, paper, paperboard stock, corrugated board, polymeric films, fabrics, metal foils, glass, glass-coated materials, flexible glass materials and laminates of multiple materials. Coarse surfaces and stretchable polymeric films are also economically printed using flexography.

Flexographic printing members are sometimes known as relief printing members, relief-containing printing plates, or printing sleeves, and are provided with raised relief images onto which ink is applied for application to a printable material. The relief printing member is typically mounted on a plate cylinder. The combination of a relief printing member and a plate cylinder onto which it is mounted form a printing cylinder. While the raised relief images are inked, the recessed relief “floor” remains free of ink.

Offset printing presses also include a printing cylinder onto which a master image is directly formed. Ink rollers transfer ink to the printing cylinder. The image is then transferred to a blanket cylinder and from the blanket cylinder to a web of print media that is fed from a supply roll to a take-up roll.

Although flexographic and offset printing have conventionally been used for the printing of images, more recent uses have included functional printing of devices, such as touch screen sensor films, antennas, and other components to be used in electronics or other industries. Such devices typically include electrically conductive patterns. Whether for printing of images or for functional printing of devices, a plurality of printing stations can be included in a flexographic or offset printing system. For example, for printing a color image on a side of a web, four printing stations are typically used for printing cyan, magenta, yellow and black inks. If suitable color-to-color registration is not maintained in the printing system, print defects such as color halos at the edges of multicolor features can result. For duplex printing, another similar set of four printing stations can be used for printing on the other side of the web.

Similarly, functional printing of devices can be done in multiple successive steps using a plurality of printing stations. If suitable registration is not maintained between printing stations, the performance of the printed device can be degraded. In many cases, the required registration tolerances for functional printing can be tighter than what is required for image printing.

Touch screens are visual displays with areas that may be configured to detect both the presence and location of a touch by, for example, a finger, a hand or a stylus. Touch screens may be found in many devices including televisions, computers, computer peripherals, mobile computing devices, automobiles, appliances and game consoles, as well as in other industrial, commercial and household applications.

A capacitive touch screen includes a substantially transparent substrate which is provided with electrically conductive patterns that do not excessively impair the transparency—either because the conductors are made of a material, such as indium tin oxide, that is substantially transparent, or because the conductors are sufficiently narrow that the transparency is provided by the comparatively large open areas not containing conductors. As the human body is also an electrical conductor, touching the surface of the screen results in a distortion of the screen's electrostatic field, measurable as a change in capacitance.

Projected capacitive touch technology is a variant of capacitive touch technology. Projected capacitive touch screens are made up of a matrix of rows and columns of conductive material that form a grid. Voltage applied to this grid creates a uniform electrostatic field, which can be measured. When a conductive object, such as a finger, comes into contact, it distorts the local electrostatic field at that point. This is measurable as a change in capacitance. The capacitance can be changed and measured at every intersection point on the grid. Therefore, this system is able to accurately track touches. Projected capacitive touch screens can use either mutual capacitive sensors or self capacitive sensors. In mutual capacitive sensors, there is a capacitor at every intersection of each row and each column. A 16×14 array, for example, would have 224 independent capacitors. A voltage is applied to the rows or columns. Bringing a finger or conductive stylus close to the surface of the sensor changes the local electrostatic field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time.

Self-capacitance sensors can use the same x-y grid as mutual capacitance sensors, but the columns and rows operate independently. With self-capacitance, the capacitive load of a finger is measured on each column or row electrode by a current meter. This method produces a stronger signal than mutual capacitance, but it is unable to resolve accurately more than one finger, which results in “ghosting”, or misplaced location sensing.

International Patent Application Publication WO 2013/063188 by Petcavich et al., entitled “Method of manufacturing a capacative touch sensor circuit using a roll-to-roll process to print a conductive microscopic patterns on a flexible dielectric substrate” discloses a method of manufacturing a capacitive touch sensor using a roll-to-roll process to print a conductor pattern on a flexible transparent dielectric substrate. A first conductor pattern is printed on a first side of the dielectric substrate using a first flexographic printing plate and is then cured. A second conductor pattern is printed on a second side of the dielectric substrate using a second flexographic printing plate and is then cured. In some embodiments the ink used to print the patterns includes a catalyst that acts as a seed layer during subsequent electroless plating. The electrolessly-plated material (e.g., copper) provides the low resistivity in the narrow lines of the grid needed for excellent performance of the capacitive touch sensor. Petcavich et al. indicate that the line width of the flexographically printed material can be 1 to 50 microns.

To improve the optical quality and reliability of the touch screen, it has been found to be preferable that the width of the grid lines be approximately 2 to 10 microns, and even more preferably to be 4 to 8 microns. In addition, multiple successive printings can be done on each side of the substrate to fabricate the touch sensor. Registration of 20 microns or tighter is needed in some instances between the different portions of the device that are printed by different printing stations.

One approach is to use in-situ measurement techniques on the printed web such that the registration of layers can be monitored and controlled to be within the required tolerance. U.S. Pat. No. 4,534,288 to Brovman, entitled “Method and apparatus for registering overlapping printed images,” discloses registration control in the context of offset printing of multicolor images. Registration marks are printed on the web at the same time that each color layer of the image is printed. The registration marks are monitored by a register control system and mechanical adjustments are made to the printing process. For example, positioning of a color plane of the image along the web motion direction (the in-track direction) to register it with portions of the image previously printed with one or more other colors can be done by introducing a phase shift of the plate cylinder relative to the web.

U.S. Patent Application Publication 2009/0283002 to Schultze, entitled “Method for printing correction,” discloses registration control in the context of flexographic printing. The position of at least one registration mark is detected using at least one sensor, and evaluation is performed in the register control unit by comparing each detected position of a printing mark with a respective reference position in order to control a relative movement of the web of printing material to the printing cylinder. A relative movement of the printing cylinder to the web means that the tangential velocity of the printing cylinder differs from the linear velocity of the printing material. The tangential speed of the printing cylinder or the linear speed of the printing material can be changed in order to achieve a relative movement. Typically the adjustments are made when the web is in contact with the printing cylinder in the margins outside of the printing region of interest to prevent ink smearing within the print. In some instances small corrections can be made within the printing region without introducing an unacceptable level of smearing.

Although methods exist for registering portions of the print that are successively printed by different printing stations, what is needed for precision printing is to design the web transport for a printing cylinder system in such a way that the size of registration errors introduced in the printing system is reduced.

### SUMMARY OF THE INVENTION

The present invention represents a printing system for printing on a web of media traveling along a web transport path, comprising:

a plurality of print stations located along the web transport path, each print station including a printing cylinder having a circumference that is substantially equal to a specified printing cylinder circumference for printing on the web of media at a corresponding print location;

a plurality of web-transport rollers to guide the web of media along the web transport path; and

one or more constrained driven rollers having an affixed driven gear, the driven gear being driven by a motor using a gear train including one or more drive gears which transfer torque from the motor to the driven gear;

wherein the driven gear and the drive gears associated with the constrained driven rollers are constrained to rotate an integer number of times for every rotation of the printing cylinders.

This invention has the advantage that disturbances in the motion of the web of media caused by any run-out or other imperfections in the gears are made more consistent by keeping the gears all in phase with printing cylinders.

It has the additional advantage that registration errors between image data printed by the different print stations are reduced.

### BRIEF DESCRIPTION OF THE DRAWINGS

FIG. 1 is a schematic side view of a portion of a flexographic printing system for roll-to-roll printing on both sides of a substrate;

FIG. 2 shows a schematic view of a portion of a printing system having a printing cylinder for printing on a web of media;

FIG. 3 shows a schematic view of a portion of a printing system having two printing cylinders for printing on a web of media;

FIG. 4 shows a schematic side view of a portion of a flexographic printing system including additional web-transport rollers near the supply roller and the take-up roller;

FIG. 5 shows components for driving the printing cylinder and the impression cylinder of FIG. 4 according to an exemplary embodiment;

FIG. 6 shows components for driving the main drive roller of FIG. 4 according to an exemplary embodiment;

FIG. 7 is a high-level system diagram for an apparatus having a touch screen with a touch sensor that can be printed using embodiments of the invention;

FIG. 8 is a side view of the touch sensor of FIG. 7;

FIG. 9 is a top view of a conductive pattern printed on a first side of the touch sensor of FIG. 8; and

FIG. 10 is a top view of a conductive pattern printed on a second side of the touch sensor of FIG. 8.

It is to be understood that the attached drawings are for purposes of illustrating the concepts of the invention and may not be to scale.

### DETAILED DESCRIPTION OF THE INVENTION

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. It should be noted that, unless otherwise explicitly noted or required by context, the word “or” is used in this disclosure in a non-exclusive sense.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention relate to web transport systems for use in a printing cylinder system such as a flexographic printing system or an offset printing system, for example for printing functional devices such as touch screen sensors. However, many other applications are emerging for printing of functional devices that can be incorporated into other electronic, communications, industrial, household, packaging and product identification systems (such as RFID) in addition to touch screens. Furthermore, flexographic printing and offset printing are conventionally used for printing of images and it is contemplated that the web transport systems described herein can also be advantageous for such printing applications.

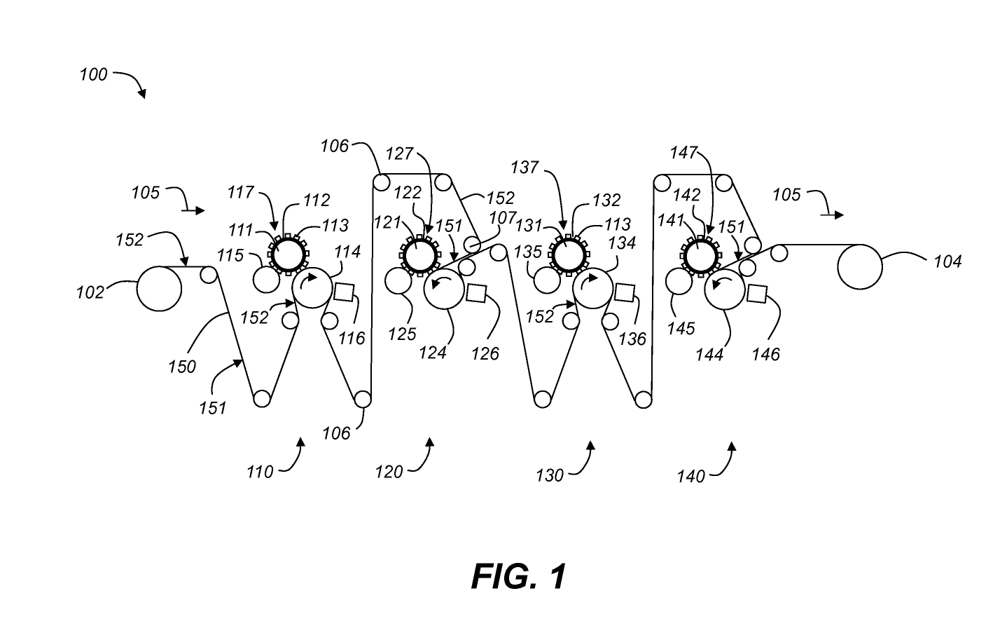

FIG. 1 is a schematic side view of a portion of a flexographic printing system 100 that can be used in embodiments of the invention for roll-to-roll printing on both sides of a web of media 150. Web of media 150 is fed from supply roll 102 to take-up roll 104 through flexographic printing system 100. Web of media 150 has a first side 151 and a second side 152.

The flexographic printing system 100 includes two print stations 120 and 140 that are configured to print on the first side 151 of the web of media 150, as well as two print stations 110 and 130 that are configured to print on the second side 152 of the web of media 150. The web of media 150 travels overall in roll-to-roll direction 105 (left-to-right in the example of FIG. 1). Various freely rotating web-transport rollers 106 and 107 (sometimes called idler rollers) between successive print stations are used to locally change the direction of the web of media 150, provide a buffer, and reverse a side for printing. In particular, note that in print station 120 the web-transport roller 107 serves to reverse the local direction of the web of media 150 so that it is moving substantially in a right-to-left direction. The entire path of the web of media 150 from the supply roll 102 to the take-up roll 104 is known as the web transport path.

Each of the print stations 110, 120, 130, 140 located along the web transport path includes a set of similar components including a respective plate cylinder 111, 121, 131, 141, on which is mounted a respective flexographic printing plate 112, 122, 132, 142, respectively. Collectively, the plate cylinder 111, 121, 131, 141 and the respective flexographic printing plate 112, 122, 132, 142 can be referred to as a printing cylinder 117, 127, 137, 147. Each flexographic printing plate 112, 122, 132, 142 has raised features 113 defining an image pattern to be printed on the web of media 150. Each print station 110, 120, 130, 140 also includes a respective impression cylinder 114, 124, 134, 144 that is configured to force a side of the web of media 150 into contact with the corresponding flexographic printing plate 112, 122, 132, 142. The impression cylinders 124 and 144 of print stations 120 and 140 (for printing on the first side 151 of the web of media 150) rotate in a counter-clockwise direction in the view shown in FIG. 1, while the impression cylinders 114 and 134 of print stations 110 and 130 (for printing on the second side 152 of the web of media 150) rotate in a clockwise direction in this view.

Each print station 110, 120, 130, 140 also includes a respective anilox roller 115, 125, 135, 145 for providing ink to the corresponding flexographic printing plate 112, 122, 132, 142. Within the context of the present invention, the term “ink” is used broadly to refer to any substance with is printed onto the web of media 150. The ink may or may not include pigments or other colorants that are visible to a human observer. As is well known in the printing industry, an anilox roller is a hard cylinder, usually constructed of a steel or aluminum core, having an outer surface containing a large number of very fine dimples, known as cells. Ink is controllably transferred and distributed onto the anilox roller by an ink pan and fountain roller (not shown) or by an ink reservoir chamber (not shown). In some embodiments, some or all of the print stations 110, 120, 130, 140 also include respective UV curing modules 116, 126, 136, 146 for curing the printed ink on web of media 150.

In a flexographic printing system or in an offset printing system, the repeat length L of printed images is substantially equal to the circumference of the printing cylinder 117, 127, 137, 147. In print station 110 of flexographic printing system 100, for example, the circumference of the printing cylinder is the outer circumference of the flexographic printing plate 112 wrapped around the plate cylinder 111. In an offset printing system (not shown) the circumference of the printing cylinder 117, 127, 137, 147 is simply the circumference of the cylinder on which the master image is formed. The length of the actual printed image is typically less than the repeat length L. There is typically a margin of unprinted substrate between two successive printed images. A complete revolution of the printing cylinder 117, 127, 137, 147 prints one repeat length L of web of media 150.

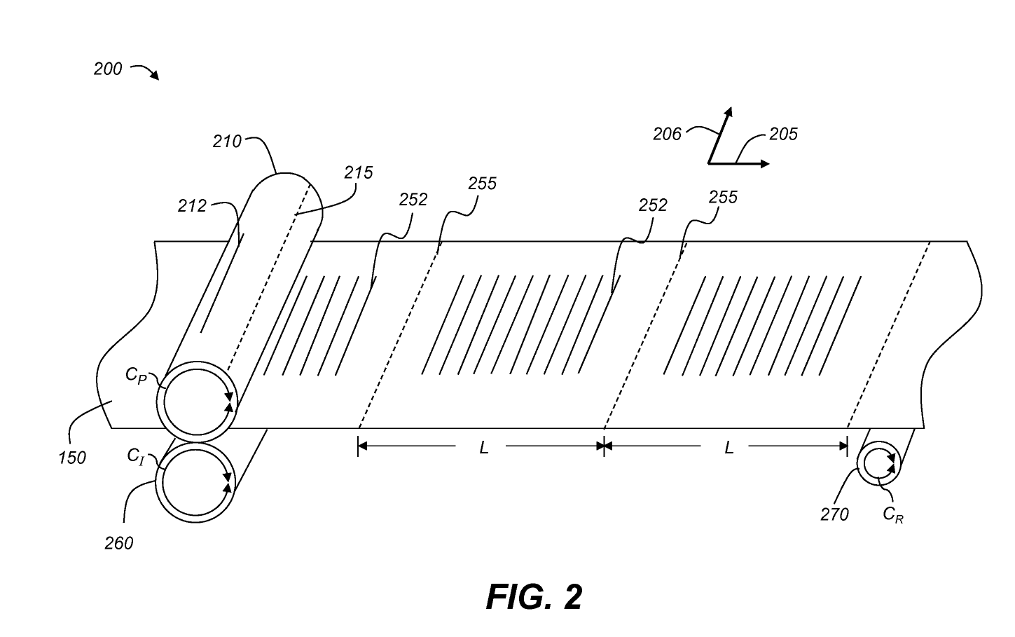

FIG. 2 shows a schematic view of a portion of a printing system 200 having a printing cylinder 210 with a master image 212 for printing a printed image 252 on web of media 150 as the web of media 150 is advanced along the in-track direction 205. A master image boundary 215 is represented using a dashed line. For the case of flexographic printing, the master image boundary 215 can represent the joint or gap between a first end and a second end of a flexographic printing plate 112 (see FIG. 1) wrapped around the plate cylinder. Printing cylinder 210 has a circumference C_{P}, which in the case of flexographic printing is the outer circumference of the flexographic printing plate 112 as mentioned above. Frame boundary 255 is represented by the dashed line superimposed on web of media 150. Printed image 252 fits between two adjacent frame boundaries 255. In this example, printed image 252 includes a set of lines that extend in the cross-track direction 206. The distance between adjacent frame boundaries 255 is repeat length L. Repeat length L is substantially equal to the circumference C_{P} of printing cylinder 210, but it can differ slightly, for example if there is slippage between web of media 150 and the printing cylinder 210 (i.e., if the web velocity is different from the tangential velocity of the printing cylinder 210). Impression cylinder 260 provides support for web of media 150 at the nip where printing cylinder 210 contacts web of media 150. Also shown is a web-transport roller 270 for supporting and guiding the web of media 150 having a circumference C_{R}.

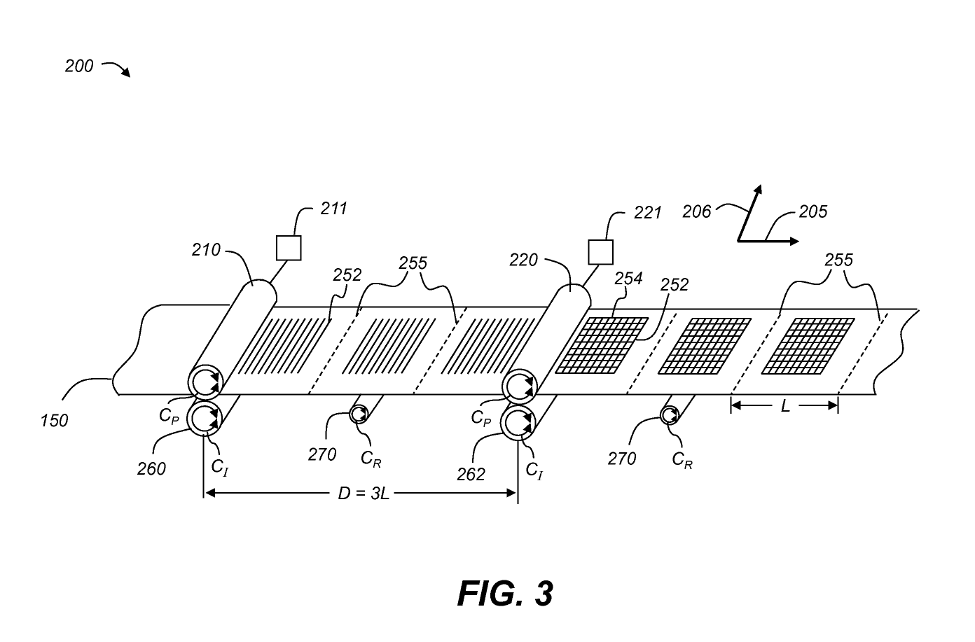

FIG. 3 is a schematic view showing more of printing system 200 of FIG. 2 so that two printing cylinders 210 and 220 are visible. Rotation of printing cylinders 210 and 220 is driven (directly or indirectly) by motors 211 and 221 respectively. In some embodiments, each of the motors 211, 221 can be used to drive a plurality of components. For example, the motor 211 can be used to drive both the printing cylinder 210 and the impression cylinder 260 through appropriate gearing. In some embodiments, additional motors (not shown in FIG. 3) can be used to drive other components, such as the impression cylinders 260, 262. For clarity, the master images on printing cylinders 210 and 220 are not shown, but printed images 252 and 254 on the web of media 150 are shown. As the web of media 150 is advanced along in-track direction 205 by drive rollers (not shown in FIG. 3), printed image 252, which includes lines extending in the cross-track direction 206, is first printed by printing cylinder 210 on a portion of the web of media 150. Subsequently, as the portion of the web of media 150 advances past printing cylinder 220, printed image 254 is printed, which includes lines extending in the in-track direction 205.

In order for the printed image 254 to have the same repeat length L as the printed image 252, the circumference of printing cylinder 220 needs to be the same as the circumference C_{P} of printing cylinder 210. In the example of FIG. 3 the span of the web of media 150 between the printing location of printing cylinder 210 (i.e., the printing nip formed with impression cylinder 260) and the printing location of printing cylinder 220 (i.e., the printing nip formed with impression cylinder 262) is equal to three repeat distances L. Several frame boundaries 255 are shown, but two frame boundaries are hidden by printing cylinders 210 and 220 respectively. Two web-transport rollers 270 are shown in FIG. 3. In this example, both web-transport rollers 270 have the same circumference C_{R}, but optionally their circumferences can be different.

In general, the size of the printing cylinders 210 and 220 needs to be large enough to accommodate the largest printed image length (i.e. the largest repeat distance L) of interest. Conventionally, the size of the web-transport rollers 270 is determined by the size and weight of the web-based media, as well as the intended web tension and the wrap angle of the media around the roller. If a web-transport roller 270 has too small a diameter, it will have insufficient strength to support the web of media 150 without flexing and causing conveyance non-uniformity.

Embodiments of the invention provide design criteria for printing systems having a plurality of print stations located along a web transport path, where each print station includes a printing cylinder, in order to reduce disturbances in the motion of the web of media as it is conveyed through the printing system. By reducing such disturbances there is greater reproducibility and registration precision in the composite printed patters that are formed by the plurality of print stations.

In particular it is observed that web-transport rollers along the web transport path (e.g., the web-transport rollers 106 and 107 in FIG. 1 or the web-transport rollers 270 in FIGS. 2 and 3) tend not to be perfectly uniform. For example, a roller can be out of round or eccentrically mounted. Such non-uniformities in the web-transport rollers supporting the web of media 150 can result in non-uniformity of motion of the web of media 150, which can be a source of various artifacts such as registration errors.

With reference to FIGS. 2 and 3, what is needed for good registration between printed images 252 and 254 along the in-track direction 205 is that the web of media 150 be moved by one repeat length L while each of the printing cylinders 210, 220 perform one revolution. The inventors have discovered that if any non-uniformities of the web-transport rollers 270 remain in phase with the complete revolution of the printing cylinders 210, 220, then the motion of the web of media 150 can be more readily controlled to move by a reproducible distance L for each revolution of printing cylinders 210, 220. It is therefore advantageous for each web-transport roller 270 to complete an integer number of revolutions while advancing the web of media 150 by one repeat length L, where the integer number is greater than or equal to 1. As noted earlier, the repeat length L is substantially the same as the printing cylinder circumference C_{P} of the printing cylinders 210, 220. Therefore, this design criterion may equivalently be stated as each of the plurality of web-transport rollers 270 between print locations associated with successive print stations having a roller circumference C_{R} that is substantially equal to an integer fraction of the specified printing cylinder circumference C_{P}. That is, the roller circumference C_{R} of each web-transport roller 270 satisfies the design criterion that:

C_{R}=L/N=C_{P}/N (1)

where N is a positive integer. By substantially equal it is meant that the roller circumference C_{R} of each of the web-transport rollers 270 is equal to an integer fraction of the specified printing cylinder circumference C_{P} to within 1.0%, and more preferably to within 0.1%.

In accordance with the present invention, any non-uniformities in the motion of the web of media 150 caused by irregularities in the web-transport rollers will be consistent at each print location, thereby reducing relative registration errors between the image content printed by the different printing cylinders 210, 211 (e.g., color-to-color registration errors). Furthermore, the registration errors for the image content printed by a particular printing cylinder 210, 211 will be much more consistent and predictable from one frame to another since the rollers will all be in consistent angular positions for a given location within the frame. As a result, the registration errors can be characterized as a function of position within the image frame (for example by using a quality control sensor to sense the position of registration marks printed in the margin of the printed image), and can be compensated for by providing a correction function which specifies compensating shifts to be applied during the process of printing the image data. For example, electronic cam gearing can be used for the printing cylinders 210, 211 to make small adjustments in the tangential velocity of the printing cylinders 210, 211 within the image frames to compensate for the measured registration errors.

It is not required that the web-transport rollers 270 all have the same roller circumference as each other, only that each web-transport roller 270 has a circumference that is an integer fraction of the printing cylinder circumference C_{P}. However, the case where all web-transport rollers 270 have the same circumference C_{R} can be advantageous from the standpoint of commonality of parts.

Preferably the impression cylinders 260, 262 are also selected to satisfy the design criteria that their circumference C_{I} be an integer fraction of the printing cylinder circumference C_{P}. Typically, the impression cylinder circumference C_{I} will be the same as the printing cylinder circumference C_{P} (i.e., N=1), however, this is not a requirement. Similarly, in a flexographic printing system the anilox rollers 115, 125, 135, 145 (FIG. 1) are also selected to satisfy the design criteria that their circumference C_{A} be an integer fraction of the printing cylinder circumference C_{P}.

Typically, all of the printing cylinders 210, 220 will have the same printing cylinder circumference C_{P}, but this is not a requirement. However, if some of the printing cylinders 210, 220 have different sizes, it is preferable that all of the printing cylinders 210, 220 have circumferences that are integer fractions of the largest printing cylinder circumference C_{P}.

Transport roller size has previously been considered in different ways for web transport in a printing system. For example, Kodak's NexPress line of color electrophotographic printers has a seamed transport web for advancing cut sheets of receiver media past a series of electrophotographic print modules. All rollers used in this assembly, including the main drive roller, tension roller, steering roller, detack roller, touch down roller, guide rollers, and paper transfer rollers are designed in a way that their circumference matches an integer fraction of the print module-to-module spacing. So, for example, the main drive roller rotates exactly 3 times while the transport web moves from one print module to the next while, the receiver media being firmly attached to the transport web. In consequence, all periodic variations due to roller run-out or unbalance that might cause an in-track timing problem stay in phase between the print modules and do not show up as a print registration problem. Line spacing might vary from the ideal 600 lines per inch, but registration is not affected because the variation occurs in the same way in all print modules. Although the motivation of improving the precision registration is similar in the present invention, the design criterion is different for web-based printing systems using printing cylinders because the fundamental distance which is used to determine the allowable roller sizes is the circumference of the printing cylinders rather than the module-to-module spacing.

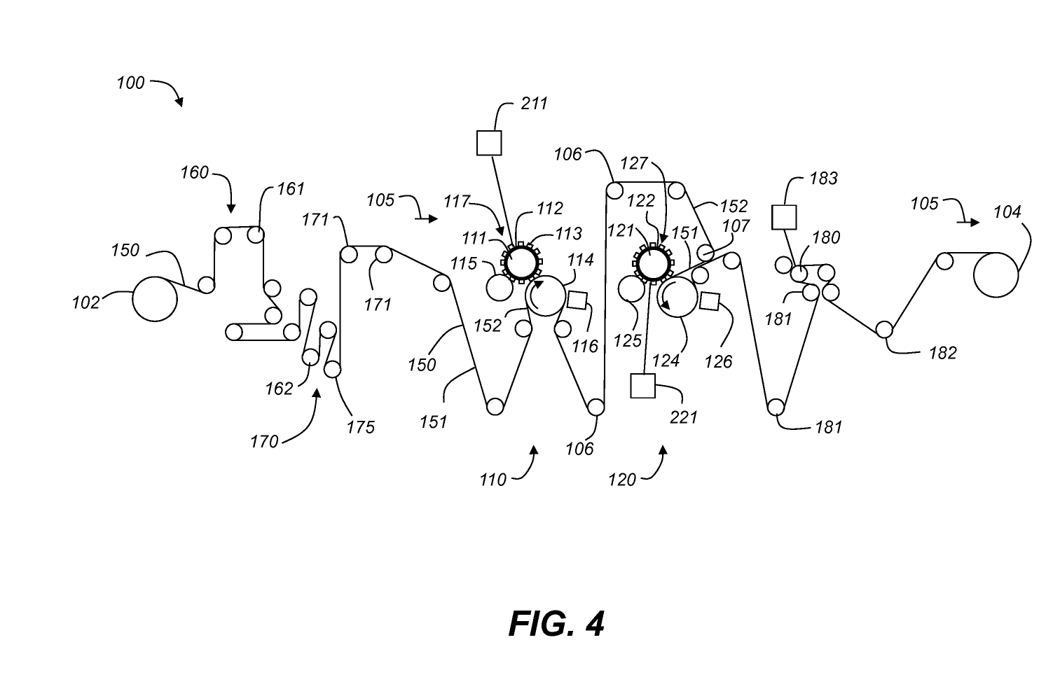

Other differences in design criteria in embodiments of the invention result from a roll-to-roll printing system architecture. With reference to FIG. 1, supply roll 102 continues to decrease in diameter, while take-up roll continues to increase in diameter as the web of media 150 is advanced through the flexographic printing system 100. FIG. 4 shows a schematic side view of a portion of a flexographic printing system 100 where only two print stations 110 and 120 are visible, in order to illustrate additional rollers between supply roll 102 and the first print station 110, as well as between the last print station 120 (in this example) and take-up roll 104.

In this exemplary embodiment, the flexographic printing system 100 includes a media guiding subsystem 160 downstream of supply roll 102. The media guiding subsystem 160 can move side to side and helps to guide web of media 150 to start down a desired path as it unwinds from supply roll 102, and generally includes one or more web-transport rollers 161 and other components such as edge guides and control systems.

An out of round supply roll 102 will cause disturbances in the motion of the web of media 150 at increasing frequency as the web is unwound. A front-end motion isolation mechanism, such as an S-wrap tensioning subsystem 170 is commonly provided to buffer such disturbances and allow a steady motion of the web of media 150 at controlled tension throughout the flexographic printing system 100. The S-wrap tensioning subsystem 170 generally includes two or more web-transport rollers 162 which define an S-shaped media path. In alternate embodiments, other types of motion isolation mechanism can be used such as slack loops or festoons. Additional web-transport rollers 171 are located along the web transport path between the S-wrap tensioning subsystem 170 and the print location associated with the first print station 110.

On the output side of the flexographic printing system 100, a main drive roller 180 driven by a motor 183 is generally used to pull the web of media 150 at a predetermined tension as measured with a load cell associated with a web-transport roller 175. The main drive roller 180 also serves the function of a back-end motion isolation mechanism to isolates the print stations 110, 120 from the take-up roll 104. In alternate embodiments, other types of motion isolation mechanism can be used such as slack loops or festoons. Additional web-transport rollers 181 and other components are also typically located along the web transport path between the print location of the last print station 120 and the take-up roll 104.

The design rule stated above that the circumference of each of the web-transport rollers 106 and 107 located along the web transport path between print locations associated with successive print stations 110 and 120, can also be applied to some or all of the rollers located along the web transport path between the supply roll 102 and the print location associated with a first print station 110 (e.g., web-transport rollers 161, 162, 175). Likewise, the design rule can also be applied to some or all of the rollers located between the print location associated with the last print station 120 and the take-up roll 104 (e.g., main drive roller 180 and web-transport rollers 181, 182). There is particular benefit to constraining the web-transport rollers 171 between the S-wrap tensioning subsystem 170 and the first print station, as well as the web-transport rollers 175, 162 in the S-wrap tensioning subsystem 170, to be selected according to the aforementioned design criterion. Since the S-wrap tensioning subsystem 170 serves to effectively isolate the supply roll 102 and media guiding subsystem 160 from the print stations 110, 120, the benefit of constraining any web-transport rollers 161 upstream of the S-wrap tensioning subsystem 170 to conform to the design criteria is reduced. Likewise, it is preferable that the main drive roller 180, as well as any web-transport rollers 181 between the last print module and the main drive roller 180, be constrained to satisfy the aforementioned design criterion. Since the main drive roller 180 effectively isolates the print stations 110, 120 from the take-up roll 104, the benefit of constraining the web-transport rollers 182 downstream of the main drive roller 180 to conform to the design rule is reduced.

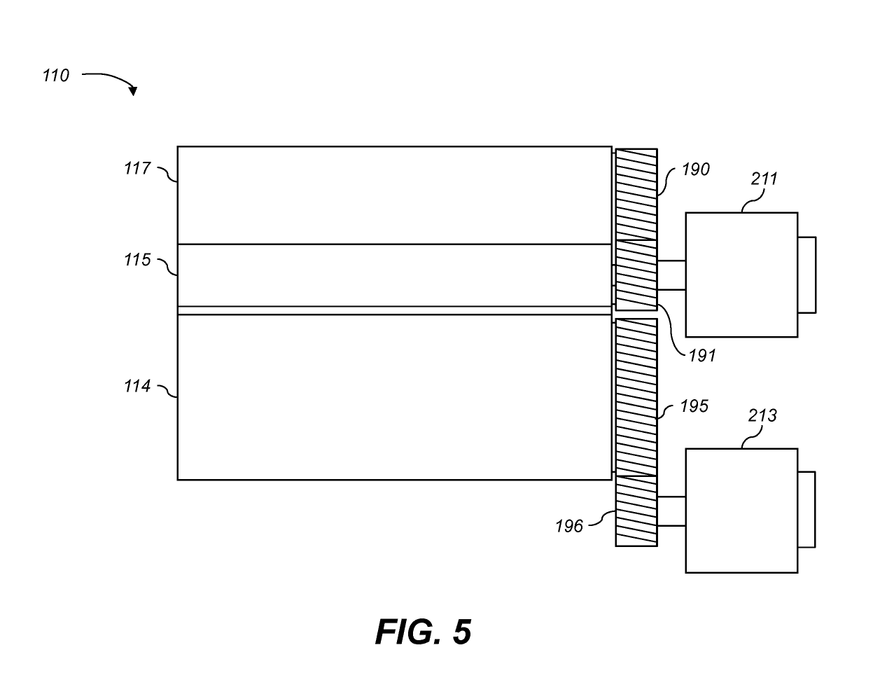

Motors 211, 221 are used to drive the printing cylinders 117, 127. In some embodiments, the printing cylinders 117, 127 are driven by the respective motors 211, 221 using a direct servo drive. In other embodiments, a driven gear can be affixed to one end of each of the printing cylinders 210, 220 and gear trains including one or more drive gears are used to transfer torque from the motors 211, 221 to the respective printing cylinders 210, 220. For example, FIG. 5 shows a rear view of components in print station 110. In this case, a driven gear 190 is affixed to one end of the printing cylinder 117. The driven gear 190 is driven by a gear train including drive gear 191, which is driven by the motor 211, which is preferably a servo drive motor. In the illustrated embodiment, the drive gear 191 is affixed to one end of the anilox roller 115, so that it rotates together with the printing cylinder 117. In other embodiments, more than one drive gear 191 can be included in the gear train between the motor 211 and the driven gear 190.

For the same reasons that were discussed earlier with respect to the diameters of the web-transport rollers, it is desirable that each of the gears (e.g., driven gear 190 and drive gear 191) in these printing cylinder gear trains should rotate an integer number of times for each rotation of the printing cylinders 117, 127. This can be achieved by constraining the gear ratios of the gears (e.g., driven gear 190 and drive gear 191) in the printing cylinder gear trains such that the gears rotate an integer number of times for each rotation of the printing cylinders 117, 127. In this case, the driven gear 190 is affixed to the end of the printing cylinder 117. Consequently, the driven gear 190 will rotate 1× for every rotation of the printing cylinder 117. In accordance with the present invention, the gear ratio for the drive gear 191 is preferably constrained to satisfy the design criteria that it rotates an integer number of times for every rotation of the printing cylinder 117. For example, if the driven gear 190 has 3× the number of teeth as the drive gear 191 (i.e., a 3:1 gear ratio), the drive gear 191 will rotate 3× for every rotation of the printing cylinder 117.

In some embodiments, the impression cylinders 114, 124 (FIG. 4) are driven by different motors 213 than are used to drive the printing cylinders 117, 127. For example, in FIG. 5, impression cylinder 114 is driven by motor 213. Driven gear 195, which is affixed to one end of the impression cylinder 114, is driven by a gear train including drive gear 196, which is driven by the motor 213. In other embodiments (not shown), the impression cylinders 114, 124 (FIG. 4) are driven by an impression cylinder gear train, including one or more impression cylinder drive gears, which rotates the impression cylinders 114, 124 in synchronization with their respective printing cylinders 117, 127. For the same reasons that were discussed earlier, it is desirable that each of the gears (i.e., driven gear 195 and drive gear 196) in the impression cylinder gear trains should be constrained to rotate an integer number of times for each rotation of the printing cylinders 210, 220. For example, if the impression cylinder 114 of FIG. 5 has the same circumference as the printing cylinder 117, the impression cylinder 114, and therefore the driven gear 195, will rotate 1× for every rotation of the printing cylinder 117. And if the driven gear 195 has 3× the number of teeth as the drive gear 196 (i.e., a 3:1 gear ratio), the drive gear 196 will rotate 3× for every rotation of the printing cylinder 117.

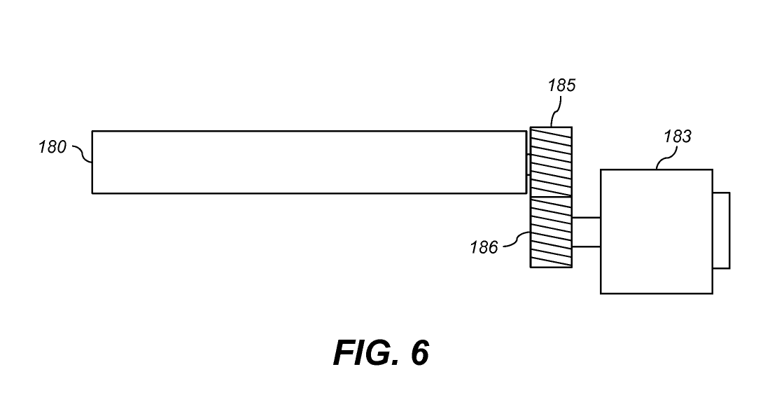

As was discussed with respect to FIG. 4, a main drive roller 180 is typically used to advance the web of media 150 through the printing system. In some embodiments, the main drive roller 180 is driven by the motor 183 using a direct servo drive. In other embodiments, a gear train including one or more drive gears 186 can be used to transfer torque from the motor 183 to a driven gear 185 affixed to the main drive roller 180 as shown in FIG. 6. In this example, the gear train includes a single drive gear 186. However, in other embodiments, more than one drive gear 186 can be included in the gear train between the motor 183 and the driven gear 185. An analogous design criterion can be applied to these gears (e.g., driven gear 185 and drive gear 186) to require that they rotate an integer number of times for every rotation of the printing cylinders 117, 127 (FIG. 4). For example, if the main drive roller 180 has a circumference which is one third of that as the printing cylinders 117, 127 (FIG. 4), the main drive roller 180, and therefore the driven gear 185, will rotate 3× for every rotation of the printing cylinders 117, 127. And if the driven gear 195 has the same number of teeth as the drive gear 186 (i.e., a 1:1 gear ratio), the drive gear 186 will rotate at the same rate as the driven gear 195, and will therefore also rotate 3× for every rotation of the printing cylinders 117, 127. The printing cylinders 117, 127, the impression cylinders 114, 124, the anilox rollers 115, 125, and the main drive roller 180 are particular types of driven rollers. The design criteria that any gears used to drive these rollers rotate an integer number of times for every rotation of the impression cylinders 114, 124 can be applied to any gear trains used to drive the different types of driven rollers.

In the some embodiments, such as the example shown in FIG. 3, the distance D along the web transport path between the print locations associated with two successive printing cylinders 210 and 220 is constrained to be an integer multiple (e.g., 3×) of the repeat length L. In other words (since the repeat length L is equal to the circumference C_{P} of the printing cylinders 210 and 220), a span of the web of media 150 between the print locations associated with two successive print stations is constrained to be an integer multiple of the specified printing cylinder circumference C_{P}:

D=M×L=M×C_{P} (2)

where M is a positive integer.

In the example shown in FIG. 1, a first span of the web of media 150 between print locations associated with first print station 110 and second print station 120 is longer than a second span of the web of media 150 between print locations associated with second print station 120 and third print station 130. In some embodiments, the first span and the second span are different, but are both integer multiples of the printing cylinder circumference.

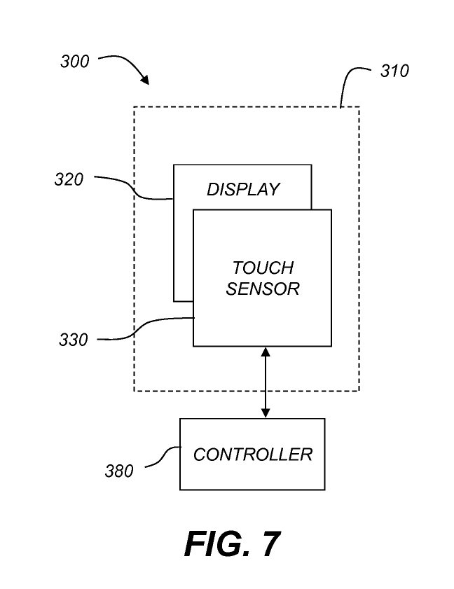

FIG. 7 shows a high-level system diagram for an apparatus 300 having a touch screen 310 including a display device 320 and a touch sensor 330 that overlays at least a portion of a viewable area of display device 320. Touch sensor 330 senses touch and conveys electrical signals (related to capacitance values for example) corresponding to the sensed touch to a controller 380. Touch sensor 330 is an example of an article that can be printed on one or both sides by the flexographic printing system 100 or printing system 200 including print stations having printing cylinders as described above for printing on a web of media 150.

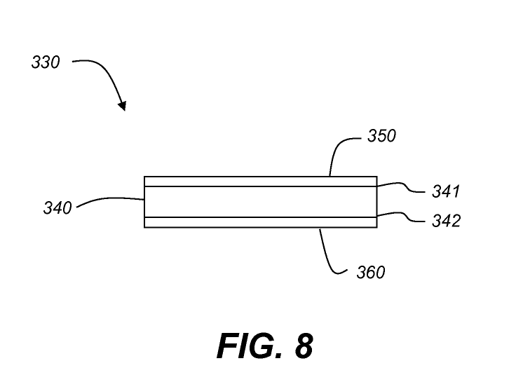

FIG. 8 shows a schematic side view of touch sensor 330. Transparent substrate 340 (corresponding to a portion of a printed web of media 150), for example polyethylene terephthalate, has a first conductive pattern 350 printed on a first side 341, and a second conductive pattern 360 printed on a second side 342. The length and width of the transparent substrate 340, which is cut from the take-up roll 104 (FIG. 1), is not larger than the flexographic printing plates 112, 122, 132, 142 of flexographic printing system 100 (FIG. 1), but it could be smaller than the flexographic printing plates 112, 122, 132, 142. This enables the printing of multiple touch sensors 330 in one revolution of the flexographic printing plates 112, 122, 132, 142 by arranging a plurality of conductive patterns within the flexographic printing plates 112, 122, 132, 142 to increase productivity. Optionally, the first conductive pattern 350 and the second conductive pattern 360 can be plated using a plating process for improved electrical conductivity after flexographic printing and curing of the patterns. In such cases it is understood that the printed pattern itself may not be conductive, but the printed pattern after plating is electrically conductive.

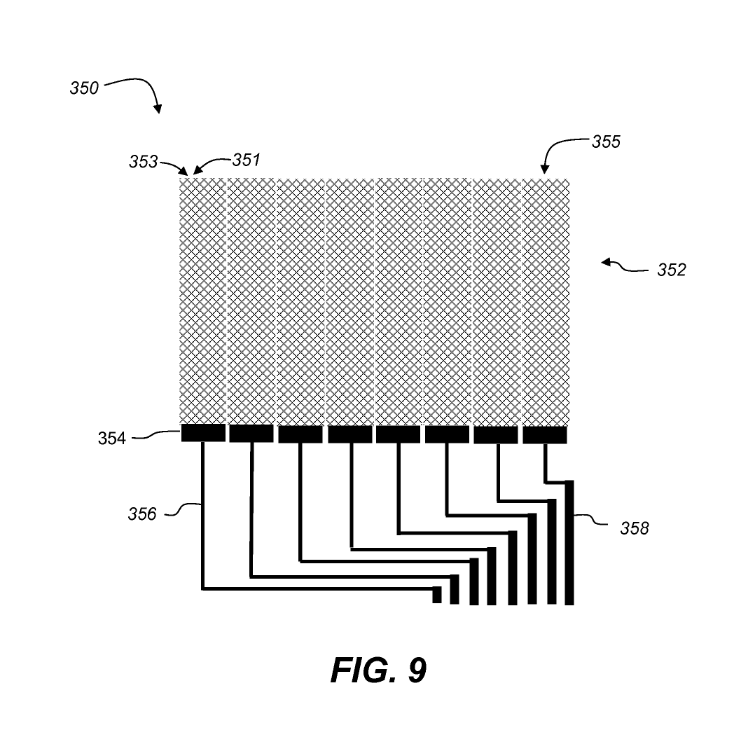

FIG. 9 shows an example of a conductive pattern 350 that can be printed on first side 341 (FIG. 8) of substrate 340 (FIG. 8) using one or more print stations such as print stations 120 and 140 of flexographic printing system 100 (FIG. 1). Conductive pattern 350 includes a grid 352 including grid columns 355 of intersecting fine lines 351 and 353 that are connected to an array of channel pads 354. Interconnect lines 356 connect the channel pads 354 to the connector pads 358 that are connected to controller 380 (FIG. 7). In some embodiments, the conductive pattern 350 can be printed using a single print station 120. However, because the optimal print conditions for fine lines 351 and 353 (e.g., having line widths on the order of 4 to 8 microns) are typically different than for printing the wider channel pads 354, connector pads 358 and interconnect lines 356, it can be advantageous to use one print station 120 for printing the fine lines 351 and 353 and a second print station 140 for printing the wider features. Furthermore, for clean intersections of fine lines 351 and 353 it can be further advantageous to print and cure one set of fine lines 351 using one print station 120, and to print and cure the second set of fine lines 353 using a second print station 140, and to print the wider features using a third print station (not shown in FIG. 1) configured similarly to print stations 120 and 140.

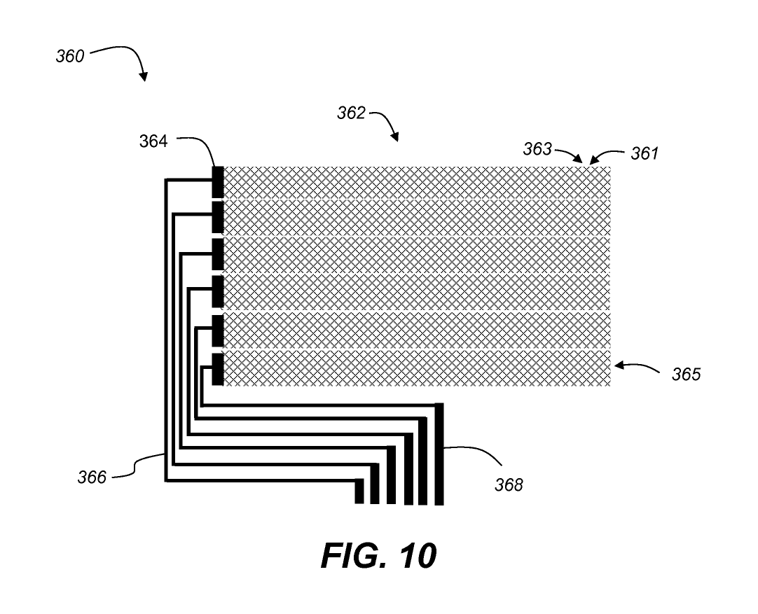

FIG. 10 shows an example of a conductive pattern 360 that can be printed on second side 342 (FIG. 8) of substrate 340 (FIG. 8) using one or more print stations such as print stations 110 and 130 of flexographic printing system (FIG. 1). Conductive pattern 360 includes a grid 362 including grid rows 365 of intersecting fine lines 361 and 363 that are connected to an array of channel pads 364. Interconnect lines 366 connect the channel pads 364 to the connector pads 368 that are connected to controller 380 (FIG. 7). In some embodiments, conductive pattern 360 can be printed using a single print station 110. However, because the optimal print conditions for fine lines 361 and 363 (e.g., having line widths on the order of 4 to 8 microns) are typically different than for the wider channel pads 364, connector pads 368 and interconnect lines 366, it can be advantageous to use one print station 110 for printing the fine lines 361 and 363 and a second print station 130 for printing the wider features. Furthermore, for clean intersections of fine lines 361 and 363 it can be further advantageous to print and cure one set of fine lines 361 using one print station 110, and to print and cure the second set of fine lines 363 using a second print station 130, and to print the wider features using a third print station (not shown in FIG. 1) configured similarly to print stations 110 and 130. It should be understood that the conductive patterns 350 and 360 shown in FIGS. 9-10 are illustrations for the purpose of clarity, and are not to scale of an actual touch sensor which must be highly transparent.

Alternatively in some embodiments conductive pattern 350 can be printed using one or more print stations configured like print stations 110 and 130, and conductive pattern 360 can be printed using one or more print stations configured like print stations 120 and 140 of FIG. 1.

With reference to FIGS. 7-10, in operation of touch screen 310, controller 380 can sequentially electrically drive grid columns 355 via connector pads 358 and can sequentially sense electrical signals on grid rows 365 via connector pads 368. In other embodiments, the driving and sensing roles of the grid columns 355 and the grid rows 365 can be reversed.

The invention has been described in detail with particular reference to certain preferred embodiments thereof, but it will be understood that variations and modifications can be effected within the spirit and scope of the invention.

### PARTS LIST

100 printing system
102 supply roll
104 take-up roll
105 roll-to-roll direction
106 web-transport roller
107 web-transport roller
110 print station
111 plate cylinder
112 flexographic printing plate
113 raised features
114 impression cylinder
115 anilox roller
116 UV curing module
117 printing cylinder
120 print station
121 plate cylinder
122 flexographic printing plate
124 impression cylinder
125 anilox roller
126 UV curing module
127 printing cylinder
130 print station
131 plate cylinder
132 flexographic printing plate
134 impression cylinder
135 anilox roller
136 UV curing module
137 printing cylinder
140 print station
141 plate cylinder
142 flexographic printing plate
144 impression cylinder
145 anilox roller
146 UV curing module
147 printing cylinder
150 web of media
151 first side
152 second side
160 media guiding subsystem
161 web-transport roller
162 web-transport roller
170 S-wrap tensioning subsystem
171 web-transport roller
175 web-transport roller
180 main drive roller
181 web-transport roller
182 web-transport roller
183 motor
185 driven gear
186 drive gear
190 driven gear
191 drive gear
195 driven gear
196 drive gear
200 printing system
205 in-track direction
206 cross-track direction
210 printing cylinder
211 motor
212 master image
213 motor
215 master image boundary
220 printing cylinder
221 motor
252 printed image
254 printed image
255 frame boundary
260 impression cylinder
262 impression cylinder
270 web-transport roller
300 apparatus
310 touch screen
320 display device
330 touch sensor
340 transparent substrate
341 first side
342 second side
350 conductive pattern
351 fine lines
352 grid
353 fine lines
354 channel pads
355 grid column
356 interconnect lines
358 connector pads
360 conductive pattern
361 fine lines
362 grid
363 fine lines
364 channel pads
365 grid row
366 interconnect lines
368 connector pads
380 controller
C_{I} impression cylinder circumference
C_{P} printing cylinder circumference
C_{R} roller circumference
D distance
L repeat length

1. A printing system for printing on a web of media traveling along a web transport path, comprising:
a plurality of print stations located along the web transport path, each print station including a printing cylinder having a circumference that is substantially equal to a specified printing cylinder circumference for printing on the web of media at a corresponding print location;
a plurality of web-transport rollers to guide the web of media along the web transport path; and
one or more constrained driven rollers having an affixed driven gear, the driven gear being driven by a motor using a gear train including one or more drive gears which transfer torque from the motor to the driven gear;
wherein the driven gear and the drive gears associated with the constrained driven rollers are constrained to rotate an integer number of times for every rotation of the printing cylinders.

2. The printing system of claim 1, wherein the printing cylinders are constrained driven rollers.

3. The printing system of claim 1, wherein each print station further includes an impression cylinder arranged so that the web of media passes through a nip formed between the printing cylinder and the corresponding impression cylinder, and wherein the impression cylinders are constrained driven rollers.

4. The printing system of claim 1, wherein each print station further includes an anilox roller arranged to transfer ink to the corresponding printing cylinder, and wherein the anilox rollers are constrained driven rollers.

5. The printing system of claim 1, wherein one or more of the web-transport rollers are constrained driven rollers.

6. The printing system of claim 1, wherein a single motor is used to drive a plurality of constrained driven rollers.

7. The printing system of claim 1, wherein all driven rollers in the printing system are constrained driven rollers.

8. The printing system of claim 1, wherein the constrained driven rollers are also constrained to have a roller circumference that is substantially equal to an integer fraction of the specified printing cylinder circumference.

9. The printing system of claim 1, wherein the web-transport rollers include one or more idler rollers.

10. The printing system of claim 6, wherein at least some of the idler rollers are constrained idler rollers that are constrained to have a roller circumference that is substantially equal to an integer fraction of the specified printing cylinder circumference.

11. The printing system of claim 7, wherein the roller circumference is equal to an integer fraction of the specified printing cylinder circumference to within 1.0%.

12. The printing system of claim 7, wherein the roller circumference is equal to an integer fraction of the specified printing cylinder circumference to within 0.1%.

13. The printing system of claim 7, wherein all of the idler rollers located along the web transport path between print locations associated with two successive print stations are constrained idler rollers.

14. The printing system of claim 7, wherein the web of media travels along the web transport path from a supply roller to a take-up roller, and wherein at least one of the constrained idler rollers is located along the web transport path between the supply roller and the print location associated with a first print station.

15. The printing system of claim 11, further including a front-end motion isolation mechanism located along the web transport path between the supply roller and the print location associated with the first print station, and wherein all of the idler rollers located along the web transport path between the front-end motion isolation mechanism and the print location associated with a first print station are constrained idler rollers.

16. The printing system of claim 7, wherein the web of media travels along the web transport path from a supply roller to a take-up roller, and wherein at least one of the constrained idler rollers is located along the web transport path between the print location associated with a last print station and the take-up roller.

17. The printing system of claim 13, further including a back-end motion isolation mechanism located along the web transport path between the print location associated with the last print station and the take-up roller, and wherein all of the idler rollers located along the web transport path between the print location associated with the last print station and the back-end motion isolation mechanism are constrained idler rollers.

18. The printing system of claim 1, wherein a span of the web of media along the web transport path between print locations associated with two successive print stations is an integer multiple of the specified printing cylinder circumference.

19. The printing system of claim 1, wherein the printing system has first, second and third print stations arranged successively along the web transport path, and wherein a first span of the web of media between print locations associated with the first and second print stations is different than a second span of the web of media between print locations associated with the second and third print stations, and wherein the first span and the second span are both integer multiples of the specified printing cylinder circumference.

20. The printing system of claim 1, wherein the printing system is a flexographic printing system or an offset printing system.

21. The printing system of claim 1, wherein at least one of the print stations prints on a first side of the web of media, and at least one of the print stations prints on an opposing second side of the web of media.

22. An article including a substrate with a printed pattern that has been printed by the printing system of claim 1.

23. The article of claim 19, wherein the article is a touch screen sensor, and wherein the pattern formed on the substrate includes a set of conductive lines.
